(19) United States
(12) Patent Application Publication
(10) Pub. No.: US 2015/0264903 A1
(43) Pub. Date: Sep. 24, 2015

(54) SELF-DESIGNED FISHING LURE

(71) Applicant: George P. Korteweg, Mystic, CT (US)

(72) Inventor: George P. Korteweg, Mystic, CT (US)

(21) Appl. No.: 14/666,853

(22) Filed: Mar. 24, 2015

Related U.S. Application Data
(60) Provisional application No. 61/969,565, filed on Mar. 24, 2014.

(51) Int. Cl. A01K 85/01; A01K 85/02; A01K 85/00

(52) U.S. Cl. CPC A01K 85/01; A01K 85/00; A01K 85/02

(57) ABSTRACT

A customizable fishing lure and kit is provided. The customizable fishing lure includes a body in the shape of an animal having at least a head portion and a tail portion. The present invention further includes a customizable portion that extends from a periphery of the body. The customizable portion is planar and therefore in the shape of a flat sheet. The customizable portion may surround at least one of the head portion and the tail portion of the body. The customizable portion is made of a cuttable material so that a user may cut out a unique appendage and create a customized lure.

### CROSS-REFERENCE TO RELATED APPLICATION

This application claims the benefit of priority of U.S. provisional application No. 61/969,565, filed Mar. 24, 2014, the contents of which are herein incorporated by reference.

### BACKGROUND OF THE INVENTION

The present invention relates to fishing lures and, more particularly, to a customizable fishing lure.

Fishing is the activity of trying to catch fish. Fishing usually takes place in the wild. Techniques for catching fish include hand gathering, spearing, netting, angling, and trapping. Angling is a method of fishing by means of an “angle” (fish hook). The hook is usually attached to a fishing line and the line is often attached to a fishing rod. Fishing rods are usually fitted with a fishing reel that functions as a mechanism for storing, retrieving and paying out the line. The hook itself can be dressed with lures or bait. A fishing lure is a type of artificial fishing bait which is designed to attract a fish's attention. The lure uses movement, vibration, flash and color to bait fish. Currently, fishing lures can be purchased only as a finished product and are not customizable.

As can be seen, there is a need for a customizable fishing lure.

### SUMMARY OF THE INVENTION

In one aspect of the present invention, a customizable fishing lure comprises: a body comprising a shape of an animal having at least a head portion and a tail portion; and a customizable portion extending from a periphery of the body, wherein the customizable portion is substantially planar and surrounds at least one of the head portion and the tail portion, wherein the customizable portion comprises a cuttable material.

In another aspect of the present invention, a customizable fishing lure kit comprises: a customizable fishing lure comprising: a body comprising a shape of an animal having at least a head portion and a tail portion; and a customizable portion extending from a periphery of the body, wherein the customizable portion is substantially planar and surrounds at least one of the head portion and the tail portion, wherein the customizable portion comprises a cuttable material; and a diagram comprising a plurality of images, wherein each image illustrates a different method of cutting the customizable portion.

In another aspect of the present invention, a method of customizing a fishing lure comprises: providing a customizable fishing lure comprising: a body comprising a shape of an animal having at least a head portion and a tail portion; and a customizable portion extending from a periphery of the body, wherein the customizable portion is substantially planar and surrounds at least one of the head portion and the tail portion; and cutting the customizable portion to represent an appendage of the animal.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is a section view of an embodiment of the present invention, taken along line 3-3 in FIG. 2;

FIG. 4 is a schematic view of an exemplary kit of the present invention;

FIG. 5 is a perspective view of an alternate embodiment of the present invention;

FIG. 6 is a section view of the present invention, taken along line 6-6 in FIG. 5; and

FIG. 7 is a perspective view of an alternate embodiment of the present invention, shown in an exemplary prepared state.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a self designed fishing lure. The designed molded form allows one to cut and create a host of artificial looking lures that float, sink, swim, run forward or backward with claws, feet, tails, and rattles.

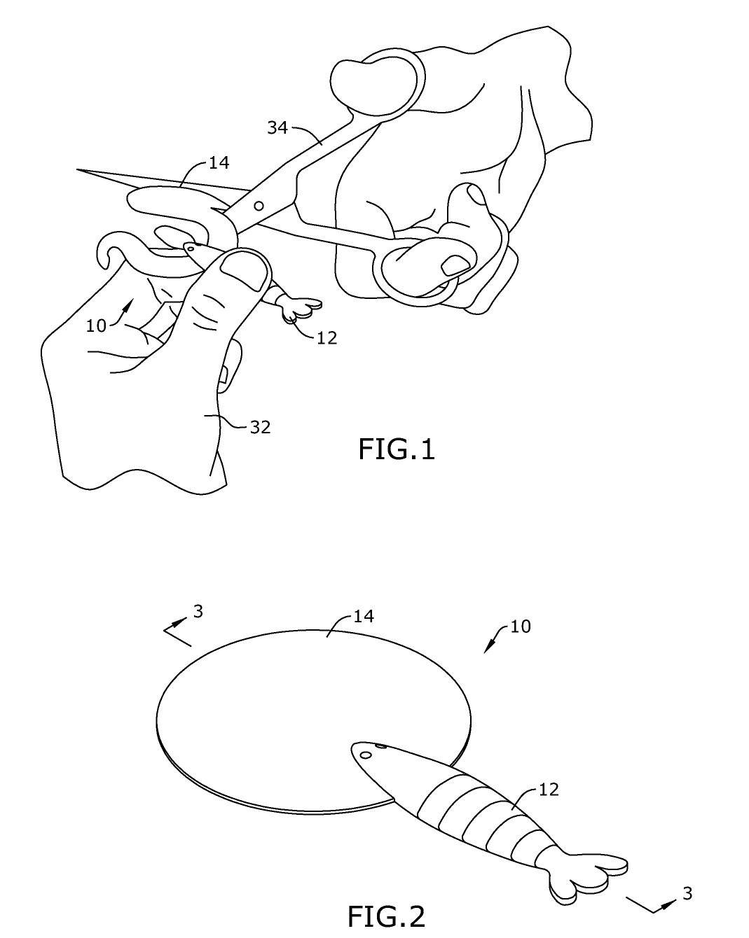

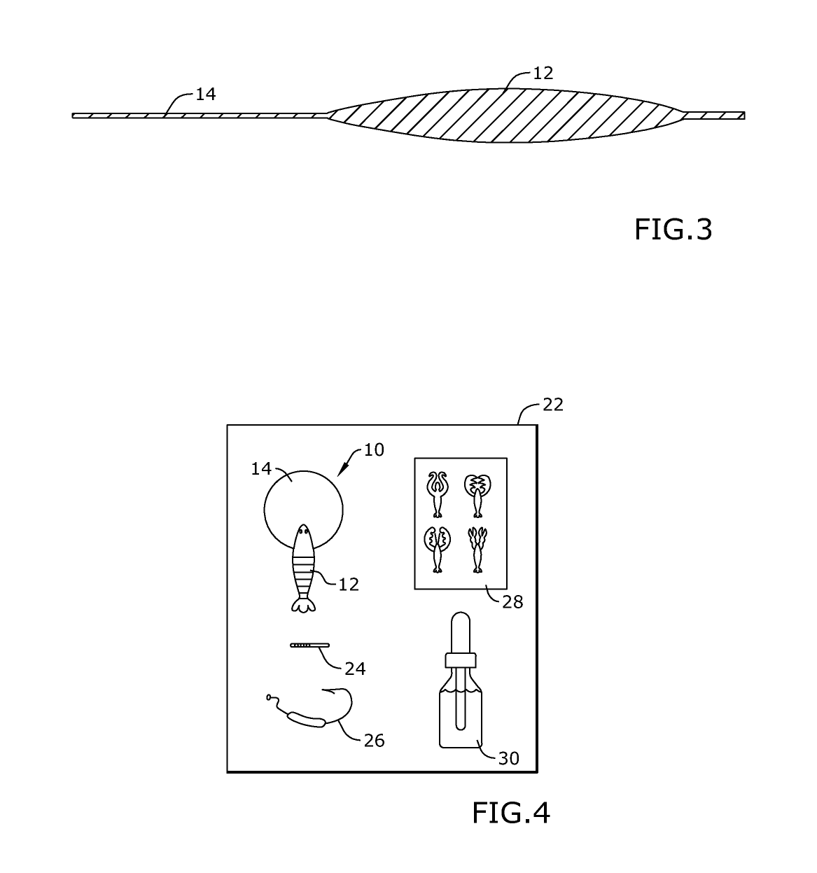

Referring to FIGS. 1 through 7, the present invention includes a customizable fishing lure 10. The customizable fishing lure 10 includes a body 12 in the shape of an animal having at least a head portion and a tail portion. The present invention further includes a customizable portion 14 that extends from a periphery of the body. The customizable portion 14 is planar and therefore in the shape of a flat sheet. The customizable portion 14 may surround at least one of the head portion and the tail portion of the body 12. The customizable portion 14 is made of a cuttable material so that a user 32 may cut out a unique appendage with a cutting tool 34 and create a customized lure 16.

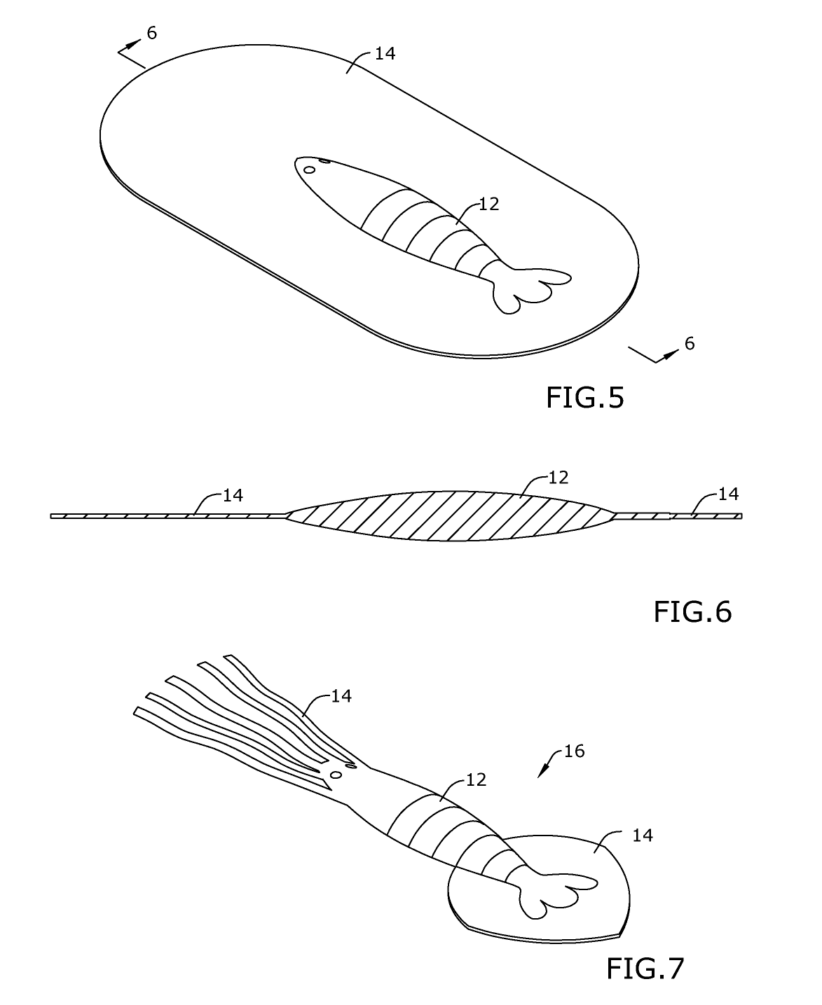

In certain embodiments, the customizable portion 14 may surround the head portion and the tail portion of the body 12. Therefore, a user may create arms and legs, as well as extend the tail portion. As illustrated in FIG. 5, the customizable portion 14 may extend from an entire periphery of the body 12 and thereby surround the entire body 12. Having an additional customizable portion 14 increases the customizable aspects of the present invention. The customizable portion 14 may be made of a soft material, such as a polymer so that users may easily cut out shapes. The softness of the polymer may have about three durometer measured with a shore A scale.

The body 12 of the present invention may further include an opening leading into an internal cavity within the body 12. The internal cavity may allow users to add additional components to the lure 10. For example, the user may add a rattle 24, scent gland oil 30, a vibrator, additional hooks and the like to further customize the lure 10.

The present invention may include a kit 22. The kit 22 may include the customizable fishing lure 10 mentioned above. The kit 22 may further include a diagram 28 including a plurality of images. Each of the images illustrates a different method of cutting the customizable portion. The kit 22 may further include a bottle with a dropper containing the scent gland oil 30. The kit 22 may further include the rattle 24. In certain embodiments, the kit 22 may come with at least one fishing hook 26 that is usable with the customizable fishing lure 10.

The present invention may further include a method of customizing a fishing lure. The method may include providing the kit mentioned above. The user may then cut the customizable portion to represent an appendage of an animal. A user may cut the customizable portion using scissors, knives, or other sharp cutting tools. The user may further insert the scent gland oil or rattle within the internal cavity of the body. Further, the user may cut the customizable portion based on the diagrams provided by the kit.

Fishing lures are made for each type fish species. Lures are designed to be used on top of the water, mid water and the bottom. The species may include crabs, worms, lobsters, shell fish, slugs, shrimp and others with segmented bodies. The above examples can be designed and sculptured using the present invention. A fisherman may select various colors along with a glow in the dark lure to work with. The designed lure is made to fish in fresh and salt waters. An unweighted hook allows the new fabricated lure to float depending on the conditions one selects.

It should be understood, of course, that the foregoing relates to exemplary embodiments of the invention and that modifications may be made without departing from the spirit and scope of the invention as set forth in the following claims.

What is claimed is:

1. A customizable fishing lure comprising:
a body comprising a shape of an animal having at least a head portion and a tail portion; and
a customizable portion extending from a periphery of the body,
wherein the customizable portion is substantially planar and surrounds at least one of the head portion and the tail portion,
wherein the customizable portion comprises a cuttable material.

2. The customizable fishing lure of claim 1, wherein the customizable portion surrounds the head portion and the tail portion.

3. The customizable fishing lure of claim 1, wherein the customizable portion extends from an entire periphery of the body and thereby surrounds the entire body.

4. The customizable fishing lure of claim 1, wherein the cuttable material is a soft polymer.

5. The customizable fishing lure of claim 1, wherein the body comprises an opening into an internal cavity.

6. The customizable fishing lure of claim 5, further comprising a rattler insertable into the internal cavity.

7. A customizable fishing lure kit comprising:
a customizable fishing lure comprising:
a body comprising a shape of an animal having at least a head portion and a tail portion; and
a customizable portion extending from a periphery of the body,
wherein the customizable portion is substantially planar and surrounds at least one of the head portion and the tail portion,
wherein the customizable portion comprises a cuttable material; and
a diagram comprising a plurality of images, wherein each image illustrates a different variation of cutting the customizable portion.

8. The customizable fishing lure kit of claim 7, wherein the customizable portion surrounds the head portion and the tail portion.

9. The customizable fishing lure kit of claim 7, wherein the customizable portion extends from an entire periphery of the body and thereby surrounds the entire body.

10. The customizable fishing lure kit of claim 7, wherein the cuttable material is a soft polymer.

11. The customizable fishing lure kit of claim 7, further comprising a rattler, wherein the body comprises an internal cavity sized to receive the rattler.

12. The customizable fishing lure kit of claim 7, further comprising a bottle containing scent gland oil, wherein the body comprises an internal cavity sized to receive the scent gland oil.

13. A method of customizing a fishing lure comprising:
providing a customizable fishing lure comprising:
a body comprising a shape of an animal having at least a head portion and a tail portion; and
a customizable portion extending from a periphery of the body,
wherein the customizable portion is substantially planar and surrounds at least one of the head portion and the tail portion; and
cutting the customizable portion to represent an appendage of the animal.

14. The method of claim 13, wherein the customizable portion surrounds the head portion and the tail portion.

15. The method of claim 13, wherein the customizable portion extends from an entire periphery of the body and thereby surrounds the entire body.

16. The method of claim 13, wherein the cuttable material is a soft polymer.

17. The method of claim 13, wherein the body comprises an opening into an internal cavity.

18. The method of claim 17, further comprising the step of: inserting a rattle into the internal cavity.

19. The method of claim 17, further comprising the step of: inserting a scent gland oil into the internal cavity.

20. The method of claim 13, further comprising the step of: providing a diagram comprising a plurality of images, wherein each image illustrates a different method of cutting the customizable portion.
